(19) United States
(12) Patent Application Publication
(10) Pub. No.: US 2023/0044091 A1
(43) Pub. Date: Feb. 9, 2023

(54) RUBBER RESIN MATERIAL WITH HIGH THERMAL CONDUCTIVITY AND METAL SUBSTRATE WITH HIGH THERMAL CONDUCTIVITY

(71) Applicant: NAN YA PLASTICS CORPORATION, TAIPEI (TW)

(72) Inventors: TE-CHAO LIAO, TAIPEI (TW); HUNG-YI CHANG, TAIPEI (TW); CHIA-LIN LIU, TAIPEI (TW)

(21) Appl. No.: 17/741,585

(22) Filed: May 11, 2022

(30) Foreign Application Priority Data
Aug. 2, 2021 (TW) 110128282

(51) Int. Cl. C08L 9/06; C08L 9/00; B32B 15/06

(52) U.S. Cl. CPC C08L 9/06; C08L 9/00; B32B 15/06; C08L 2201/08; C08L 2203/20; B32B 2307/302; B32B 2307/204; B32B 2250/02

(57) ABSTRACT

A rubber resin material with high thermal conductivity and a metal substrate with high thermal conductivity are provided. The rubber resin material includes inorganic fillers and a rubber resin composition with high thermal conductivity. The rubber resin composition with high thermal conductivity includes 40 wt % to 70 wt % of a liquid rubber, 10 wt % to 30 wt % of a polyphenylene ether resin, and 20 wt % to 40 wt % of a crosslinker. A molecular weight of the liquid rubber ranges from 800 g/mol to 6000 g/mol. The inorganic fillers undergo a surface modification process to have at least one of an acryl group and an ethylene group.

### CROSS-REFERENCE TO RELATED PATENT APPLICATION

This application claims the benefit of priority to Taiwan Patent Application No. 110128282, filed on Aug. 2, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a rubber resin material and a metal substrate, and more particularly to a rubber resin material with high thermal conductivity and a metal substrate with high thermal conductivity.

### BACKGROUND OF THE DISCLOSURE

With the advancement of the fifth generation wireless system (5G wireless system), high frequency transmission has undoubtedly become the main development trend in an attempt to meet requirements of the 5G wireless system. Accordingly, relevant industries have strived to develop a high frequency substrate material for high frequency transmission (e.g., a frequency ranging from 6 GHz to 77 GHz), such that a high frequency substrate can be applied to a base station antenna, a satellite radar, an automotive radar, a wireless communication antenna, or a power amplifier.

The high frequency substrate usually has a low dielectric constant (Dk) and a low dielectric dissipation factor (DO, so as to be used for high frequency transmission. Hereinafter, the dielectric constant and the dielectric dissipation factor are collectively referred to as dielectric properties of the high frequency substrate.

A resin material with high thermal conductivity that is currently available on the market usually contains a certain amount of thermal conductive fillers to increase the thermal conductivity of the resin material. Relative to 100 parts per hundred resin (phr), an amount of the thermal conductive fillers ranges from a value larger than 45 phr to 60 phr. However, an excessive amount of the thermal conductive fillers can negatively influence a compatibility between the resin material and the thermal conductive fillers, such that a thermal resistance of a metal substrate is decreased and the resin material is not suitable to be applied to the high frequency substrate material.

Therefore, a resin material and a metal substrate with high thermal conductivity that can be applied to the field of high frequency transmission due to having a good thermal conductivity, a good thermal resistance, and a good peeling strength, has yet to be provided in the relevant industry.

### SUMMARY OF THE DISCLOSURE

In response to the above-referenced technical inadequacies, the present disclosure provides a rubber resin material with high thermal conductivity and a metal substrate with high thermal conductivity.

In one aspect, the present disclosure provides a rubber resin material with high thermal conductivity. The rubber resin material includes a rubber resin composition with high thermal conductivity and inorganic fillers. The rubber resin composition with high thermal conductivity includes 40 wt % to 70 wt % of a liquid rubber, 10 wt % to 30 wt % of a polyphenylene ether resin, and 20 wt % to 40 wt % of a crosslinker. A molecular weight of the liquid rubber ranges from 800 g/mol to 6000 g/mol. The inorganic fillers undergo a surface modification process to have at least one of an acryl group and an ethylene group.

In certain embodiments, monomers forming the liquid rubber include a styrene monomer and a butadiene monomer. Based on a total weight of the liquid rubber being 100 wt %, an amount of the styrene monomer ranges from 10 wt % to 50 wt %.

In certain embodiments, based on a total weight of the butadiene monomer being 100 wt %, 30 wt % to 90 wt % of the butadiene monomer has a side chain containing an ethylene group.

In certain embodiments, the inorganic fillers include a thermal conductive filler. The thermal conductive filler undergo the surface modification process to have at least one of an acryl group and an ethylene group.

In certain embodiments, the thermal conductive filler is selected from the group consisting of: aluminum oxide, boron nitride, magnesium oxide, zinc oxide, aluminum nitride, silicon carbide, and aluminum silicate.

In certain embodiments, relative to 100 phr of the rubber resin composition with high thermal conductivity, an amount of the thermal conductive filler ranges from 100 phr to 150 phr.

In certain embodiments, the thermal conductive filler includes aluminum oxide, boron nitride, and aluminum silicate. Relative to 100 phr of the rubber resin composition with high thermal conductivity, an amount of the aluminum oxide ranges from 5 phr to 120 phr, and amount of the boron nitride ranges from 10 phr to 100 phr, and an amount of the aluminum silicate ranges from 30 phr to 80 phr.

In certain embodiments, the inorganic fillers include a dielectric filler, and the dielectric filler includes silicon dioxide.

In certain embodiments, relative to 100 phr of the rubber resin composition with high thermal conductivity, an amount of the dielectric filler ranges from 50 phr to 100 phr.

In certain embodiments, the rubber resin material with high thermal conductivity further includes a siloxane coupling agent. The siloxane coupling agent has at least one of an acryl group and an ethylene group.

In certain embodiments, relative to 100 phr of the rubber resin composition with high thermal conductivity, an amount of the siloxane coupling agent ranges from 0.1 phr to 5 phr.

In another aspect, the present disclosure provides a metal substrate with high thermal conductivity. The metal substrate with high thermal conductivity includes a substrate layer and a metal layer disposed on the substrate layer. The substrate layer is formed from a rubber resin material with high thermal conductivity. The rubber resin material with high thermal conductivity includes a rubber resin composition with high thermal conductivity and inorganic fillers. The rubber resin composition with high thermal conductivity includes 40 wt % to 70 wt % of a liquid rubber, 10 wt % to 30 wt % of a polyphenylene ether resin, and 20 wt % to 40 wt % of a crosslinker. A molecular weight of the liquid rubber ranges from 800 g/mol to 6000 g/mol. The inorganic fillers undergo a surface modification process to have at least one of an acryl group and an ethylene group.

In certain embodiments, a thermal conductivity of the metal substrate with high thermal conductivity is higher than or equal to 1.2 W/m·K.

In certain embodiments, a peeling strength of the metal substrate with high thermal conductivity ranges from 4.5 lb/in to 7.0 lb/in.

In certain embodiments, the metal substrate with high thermal conductivity has a dielectric constant ranging from 3.5 to 4.5 and a dielectric dissipation factor being lower than or equal to 0.0035.

Therefore, in the rubber resin material with high thermal conductivity and the metal substrate with high thermal conductivity provided by the present disclosure, by virtue of “the rubber resin composition with high thermal conductivity including 40 wt % to 70 wt % of a liquid rubber” and “the inorganic fillers undergoing a surface modification process to have at least one of an acryl group and an ethylene group,” the rubber resin material and the metal substrate can be improved with respect to their dielectric properties, peeling strength, thermal resistance, and thermal conductivity.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Rubber Resin Material with High Thermal Conductivity]

In the present disclosure, a rubber resin material with high thermal conductivity (or a rubber resin material for short) contains inorganic fillers. The inorganic fillers undergo a surface modification process, so that a surface of the inorganic fillers has at least one of an acryl group and an ethylene group. Accordingly, an amount of the inorganic fillers added in the rubber resin material can be higher than an upper limit value of the inorganic fillers that are added in the related art. Therefore, the rubber resin material of the present disclosure is more suitable to be used as a high frequency substrate material.

Specifically, the rubber resin material of the present disclosure includes a rubber resin composition with high thermal conductivity (or a rubber resin composition for short) and the inorganic fillers. The inorganic fillers are uniformly dispersed in the rubber resin composition. Specific properties of the rubber resin composition and the inorganic fillers will be illustrated below.

[Rubber Resin Composition with High Thermal Conductivity]

The rubber resin composition of the present disclosure includes: 40 wt % to 70 wt % of a liquid rubber, 10 wt % to 30 wt % of a polyphenylene ether resin, and 20 wt % to 40 wt % of a crosslinker.

Through the aforesaid components and contents, the rubber resin composition of the present disclosure can be used to manufacture a metal substrate with high thermal conductivity (or a metal substrate for short) that has a good thermal conductivity, good dielectric properties, and a good thermal resistance. In addition, the metal substrate can have a strong adhesive force with a metal layer. Property tests of the metal substrate will be illustrated below.

When a molecular weight of the liquid rubber ranges from 800 g/mol to 6000 g/mol, flowability of the rubber resin composition can be enhanced such that a glue filling property of the rubber resin composition can also be enhanced. Preferably, the molecular weight of the liquid rubber ranges from 1000 g/mol to 5500 g/mol.

It is worth mentioning that in the present disclosure, an amount of the liquid rubber in the rubber resin composition can be increased due to control of the molecular weight of the liquid rubber and control of components and structures of monomers forming the liquid rubber. Specifically, based on a total weight of the rubber resin composition being 100 wt %, the amount of the liquid rubber is higher than 40 wt %, and is obviously higher than an amount of the liquid rubber in the related art (which is 25 wt %). In an exemplary embodiment, the rubber resin composition contains 40 wt % to 70 wt % of the liquid rubber.

In certain embodiments, the liquid rubber includes a liquid diene rubber. Specifically, the liquid diene rubber includes a polybutadiene resin. The polybutadiene resin is a polymer polymerized from butadiene monomers, such as a butadiene homopolymer or a copolymer formed from butadiene and other monomers.

In an exemplary embodiment, the liquid diene rubber is a copolymer formed from butadiene and styrene. In other words, the monomers forming the liquid rubber include styrene and butadiene. A styrene monomer and a butadiene monomer can be randomly arranged to form a random copolymer, or can be regularly arranged to form an alternating copolymer or a block copolymer.

Based on a total weight of the liquid rubber being 100 wt %, an amount of the styrene monomer ranges from 10 wt % to 50 wt %. When the liquid rubber contains 10 wt % to 50 wt % of the styrene monomer, the liquid rubber can easily be arranged to have a structure similar to liquid crystals, thereby enhancing a thermal resistance and compatibility of the liquid rubber. Preferably, the liquid rubber contains 15 wt % to 50 wt % of the styrene monomer. When the amount of the styrene monomer is higher than 50 wt %, a viscosity of the rubber resin material will be increased, which is disadvantageous for manufacturing the metal substrate.

Specifically, the butadiene monomer has two double bonds. Hence, different ways of polymerizing the butadiene monomer can result in different structures of the polybutadiene resin. In other words, the polybutadiene resin can include one or more structures of: cis-1, 4-polybutadiene, trans-1, 4-polybutadiene, and 1, 2-polybutadiene. When the butadiene is polymerized through a 1, 4-addition reaction, the structure of cis-1, 4-polybutadiene or trans-1, 4-polybutadiene can be formed. In the structure of cis-1, 4-polybutadiene or trans-1, 4-polybutadiene, neither cis-1, 4-polybutadiene nor trans-1, 4-polybutadiene has an unsaturated side chain. When the butadiene is polymerized through a 1, 2-addition reaction, the structure of 1, 2-polybutadiene can be formed. In the structure of 1, 2-polybutadiene, 1, 2-polybutadiene has an unsaturated side chain (such as an ethylene group).

In an exemplary embodiment, based on a total weight of the butadiene monomers being 100 wt %, 30 wt % to 90 wt % of the butadiene monomers (after being polymerized) have a side chain containing an ethylene group. Preferably, based on the total weight of the butadiene monomers being 100 wt %, 30 wt % to 80 wt % of the butadiene monomers (after being polymerized) have the side chain containing an ethylene group, or 30 wt % to 80 wt % of the butadiene monomers (after being polymerized) have an ethylene side chain.

When the liquid rubber has at least one unsaturated side chain containing an ethylene group (or an ethylene side chain), a crosslinking density and a thermal resistance of the rubber resin composition after being crosslinked can be enhanced. In the present disclosure, an amount of the unsaturated side chain containing an ethylene group (or an ethylene side chain) in the liquid rubber can be quantified by an iodine value in a chemistry analysis.

The higher the amount of the unsaturated side chain containing an ethylene group (or an ethylene side chain) in the liquid rubber is, the higher the iodine value of the liquid rubber is. Physical properties of the rubber resin composition after being crosslinked can be enhanced by the unsaturated side chain containing an ethylene group (or an ethylene side chain). In an exemplary embodiment, the iodine value of the liquid rubber of the present disclosure ranges from 30 g/100 g to 60 g/100 g.

In the present disclosure, in order to measure the iodine value of the liquid rubber, 0.3 mg to 1 mg of the liquid rubber is completely dissolved in chloroform, and is placed in the dark for 30 minutes after a Wijs solution is added thereinto. Next, 20 ml of a potassium iodide solution (100 g/L) and 100 ml of water are added to form an analyte. Subsequently, the analyte is titrated by a sodium thiosulfate solution (0.1 mol/L) which is used as a titrant. When a color of the analyte becomes light yellow, a few drops of a starch solution are dripped into the analyte. Then, the analyte is further titrated until a blue color of the analyte disappears.

In the present disclosure, a molecular weight of the polyphenylene ether resin ranges from 1000 g/mol to 20000 g/mol. Preferably, the molecular weight of the polyphenylene ether resin ranges from 2000 g/mol to 10000 g/mol. More preferably, the molecular weight of the polyphenylene ether resin ranges from 2000 g/mol to 2200 g/mol. When the molecular weight of the polyphenylene ether resin is lower than 20000 g/mol, a solubility of the polyphenylene ether resin in a solvent can be enhanced, which is advantageous for preparing the rubber resin composition.

In an exemplary embodiment, the polyphenylene ether resin can have at least one modified group. The modified group can be selected from the group consisting of: a hydroxyl group, an amino group, an ethylene group, a styrene group, a methacryl group, and an epoxy group. The modified group of the polyphenylene ether resin can provide an unsaturated bond, so as to facilitate a crosslinking reaction. In this way, a material that has a high glass transition temperature and a good thermal resistance can be obtained. In the present embodiment, two molecular ends of the polyphenylene ether resin each have the modified group, and the two modified groups are the same.

In an exemplary embodiment, the polyphenylene ether resin can include one kind of polyphenylene ether or various kinds of polyphenylene ether.

For example, the polyethylene ether can be a polyphenylene ether that has two hydroxyl modified groups at molecular ends thereof, a polyphenylene ether that has two methacryl modified groups at molecular ends thereof, a polyphenylene ether that has two styrene modified groups at molecular ends thereof, or a polyphenylene ether that has two epoxy modified groups at molecular ends thereof. However, the present disclosure is not limited thereto.

In certain embodiments, the polyphenylene ether resin includes a first polyphenylene ether and a second polyphenylene ether. Molecular ends of both the first polyphenylene ether and the second polyphenylene ether each have at least one modified group. The modified group can be selected from the group consisting of: a hydroxyl group, an amino group, an ethylene group, a styrene group, a methacryl group, and an epoxy group. In addition, the modified group of the first polyphenylene ether and the modified group of the second polyphenylene ether can be different from each other. Specifically, a weight ratio of the first polyphenylene ether to the second polyphenylene ether ranges from 0.5 to 1.5. Preferably, the weight ratio of the first polyphenylene ether to the second polyphenylene ether ranges from 0.75 to 1.25. More preferably, the weight ratio of the first polyphenylene ether to the second polyphenylene ether is 1.

For example, the first polyphenylene ether and the second polyphenylene ether can independently be the polyphenylene ether that has two hydroxyl modified groups at the molecular ends thereof, the polyphenylene ether that has two methacryl modified groups at the molecular ends thereof, the polyphenylene ether that has two styrene modified groups at the molecular ends thereof, or the polyphenylene ether that has two epoxy modified groups at the molecular ends thereof. However, the present disclosure is not limited thereto.

The crosslinker of the present disclosure can enhance a crosslinking degree of the polyphenylene ether resin and the liquid rubber. In the present embodiment, the crosslinker can include an allyl group. For example, the crosslinker can be triallyl cyanurate (TAC), triallyl isocyanurate (TAIC), diallyl phthalate, divinylbenzene, triallyl trimellitate, or any combination thereof. Preferably, the crosslinker can be triallyl isocyanurate. However, the present disclosure is not limited thereto.

### Inorganic Fillers

The inorganic fillers can include a thermal conductive filler and a dielectric filler. The thermal conductive filler can be used to enhance a thermal conductivity of the rubber resin material. The dielectric filler can be used to enhance the dielectric properties of the rubber resin material. However, the present disclosure is not limited thereto.

### Thermal Conductive Filler

An addition of the thermal conductive filler can help decrease the viscosity of the rubber resin material and enhance the thermal conductivity of the rubber resin material. For example, the thermal conductive filler can be selected from the group consisting of: aluminum oxide, boron nitride, magnesium oxide, zinc oxide, aluminum nitride, silicon carbide, aluminum silicate, and any combination thereof. However, the present disclosure is not limited thereto. In an exemplary embodiment, the thermal conductive filler includes at least one of aluminum oxide and boron nitride.

The thermal conductive filler of the present disclosure undergoes a surface modification process, so that a surface of the thermal conductive filler can have at least one of an acryl group and an ethylene group. Accordingly, the thermal conductive filler and the liquid rubber can be reacted with each other, thereby allowing the rubber resin composition to have a good compatibility without negatively influencing the thermal resistance of the metal substrate.

It should be noted that the thermal conductive filler can contain one component or various components. In addition, the thermal conductive filler can completely undergo the surface modified process to have at least one of an acryl group and an ethylene group, or only a part of the thermal conductive filler undergoes the surface modified process to have at least one of an acryl group and an ethylene group. For example, when the thermal conductive filler includes aluminum oxide and boron nitride, one configuration is to allow the aluminum oxide (but not the boron nitride) to undergo the surface modification process and have at least one of an acryl group and an ethylene group. However, the present disclosure is not limited thereto.

In an exemplary embodiment, the thermal conductive filler includes aluminum oxide, boron nitride, and aluminum silicate. Relative to 100 phr of the rubber resin composition, an amount of aluminum oxide ranges from 5 phr to 120 phr, an amount of boron nitride ranges from 10 phr to 100 phr, and an amount of aluminum silicate ranges from 30 phr to 80 phr.

Specifically, for the surface modification process, the thermal conductive filler can be immersed into a siloxane that has a specific functional group (such as a siloxane having an ethylene group or a siloxane having an acryl group), so that the thermal conductive filler can have at least one of an acryl group and an ethylene group.

An amount of the thermal conductive filler can be adjusted according to product requirements. In certain embodiments, based on the total weight of the rubber resin composition being 100 phr, the amount of the thermal conductive filler ranges from 100 phr to 150 phr. Preferably, based on the total weight of the rubber resin composition being 100 phr, the amount of the thermal conductive filler ranges from 110 phr to 140 phr. More preferably, based on the total weight of the rubber resin composition being 100 phr, the amount of the thermal conductive filler ranges from 120 phr to 130 phr. However, the present disclosure is not limited thereto.

An appearance of the thermal conductive filler can be granular or flaky. Preferably, the appearance of the thermal conductive filler is flaky. An average particle size of the thermal conductive filler ranges from 0.3 μm to 30 μm. The particle size of the thermal conductive filler is within a range between 0.3 μm and 30 μm, so that the thermal conductive filler can be uniformly dispersed in the rubber resin composition.

### Dielectric Filler

An addition of the dielectric filler can help decrease the viscosity of the rubber resin material and decrease the dielectric constant of the rubber resin material. For example, the dielectric filler can be silicon dioxide, titanium dioxide, aluminum hydroxide, magnesium hydroxide, calcium carbonate, boron oxide, calcium oxide, strontium titanate, barium titanate, calcium titanate, magnesium titanate, cerium oxide, or any combination thereof. However, the present disclosure is not limited thereto. In an exemplary embodiment, the dielectric filler includes silicon dioxide. The silicon dioxide can be fused silica or crystalline silica. Preferably, the silicon dioxide is fused silica.

In an exemplary embodiment, the dielectric filler undergoes a surface modification process, so that a surface of the dielectric filler can have at least one of an acryl group and an ethylene group. Accordingly, the dielectric filler and the liquid rubber can be reacted with each other, thereby allowing the rubber resin composition to have a good compatibility without negatively influencing the thermal resistance of the metal substrate.

Specifically, the surface modified process for the dielectric filler is similar to the surface modified process for the thermal conductive filler, and will not be repeated herein.

An appearance of the dielectric filler can be spherical. An average particle size of the dielectric filler ranges from 0.3 μm to 30 μm. The particle size of the dielectric filler is within a range between 0.3 μm and 30 μm, such that the dielectric filler can be uniformly dispersed in the rubber resin composition.

In an exemplary embodiment, a purity of the dielectric filler is higher than or equal to 99.95%. In other words, an amount of metal impurities in the dielectric filler is lower than or equal to 500 ppm. Specifically, an amount of calcium element in the dielectric filler is lower than or equal to 200 ppm, an amount of aluminum element in the dielectric filler is lower than or equal to 200 ppm, and an amount of iron element in the dielectric filler is lower than or equal to 100 ppm. When the purity of the dielectric filler is higher than or equal to 99.95%, a dielectric dissipation factor of the metal substrate can be maintained to be lower than or equal to 0.002 (10 GHz). Preferably, the dielectric dissipation factor of the metal substrate is lower than or equal to 0.0018.

An amount of the dielectric filler can be adjusted according to product requirements. In certain embodiments, based on the total weight of the rubber resin composition being 100 phr, the amount of the dielectric filler ranges from 5 phr to 150 phr. Preferably, based on the total weight of the rubber resin composition being 100 phr, the amount of the dielectric filler ranges from 5 phr to 120 phr. More preferably, based on the total weight of the rubber resin composition being 100 phr, the amount of the dielectric filler ranges from 5 phr to 90 phr. However, the present disclosure is not limited thereto.

### Siloxane Coupling Agent

The rubber resin material can further include a siloxane coupling agent. An addition of the siloxane coupling agent can enhance a reactivity and a compatibility among a fiber cloth, the rubber resin composition and the fillers (including the thermal conductive filler and the dielectric filler), thereby enhancing a peeling strength and the thermal resistance of the metal substrate.

In an exemplary embodiment, the siloxane coupling agent has at least one of an acryl group and an ethylene group. A molecular weight of the siloxane coupling agent ranges from 100 g/mol to 500 g/mol. Preferably, the molecular weight of the siloxane coupling agent ranges from 110 g/mol to 250 g/mol. More preferably, the molecular weight of the siloxane coupling agent ranges from 120 g/mol to 200 g/mol.

Relative to 100 phr of the rubber resin composition, an amount of the siloxane coupling agent ranges from 0.1 phr to 5 phr. Preferably, the amount of the siloxane coupling agent ranges from 0.5 phr to 3 phr.

### Flame Retardant

The rubber resin material can further include a flame retardant. An addition of the flame retardant can enhance a flame retardant property of a high frequency substrate. For example, the flame retardant can be a phosphorus flame retardant or a brominated flame retardant. Preferably, the flame retardant is a halogen-free flame retardant. That is, the flame retardant does not contain halogen.

The brominated flame retardant can be ethylene bistetrabromophthalimide, tetradecabromodiphenoxy benzene, decabromo diphenoxy oxide, or any combination thereof, but is not limited thereto.

The phosphorus flame retardant can be sulphosuccinic acid ester, phosphazene, ammonium polyphosphate, melamine polyphosphate, melamine cyanurate, or any combination thereof. The sulphosuccinic acid ester includes triphenyl phosphate (TPP), tetraphenyl resorcinol bis(diphenylphosphate) (RDP), bisphenol A bis(diphenyl phosphate) (BPAPP), bisphenol A bis(dimethyl) phosphate (BBC), resorcinol diphosphate (such as the model CR-733S produced by DAIHACHI), or resorcinol-bis(di-2,6-dimethylphenyl phosphate) (such as the model PX-200 produced by DAIHACHI). However, the present disclosure is not limited thereto.

An amount of the flame retardant can be adjusted according to product requirements. In certain embodiments, relative to 100 phr of the rubber resin composition, the amount of the flame retardant ranges from 0.1 phr to 5 phr.

### Property Test

In order to prove that the rubber resin material can be used as a high frequency substrate material, 40 wt % to 70 wt % of the liquid rubber, 10 wt % to 30 wt % of the polyphenylene ether resin, and 20 wt % to 40 wt % of the crosslinker are mixed to form the rubber resin composition. In addition, the thermal conductive filler and the dielectric filler are further added into the rubber resin composition, so as to form the rubber resin material of Examples 1 to 6 and Comparative Examples 1 to 3. Specific contents of the rubber resin material of Examples 1 to 6 and Comparative Examples 1 to 3 are listed in Table 1.

In Table 1, the liquid rubber can be a butadiene/styrene copolymer, a copolymer polymerized from butadiene and other monomers (excluding styrene), or a butadiene homopolymer. Specifically, models of the butadiene/styrene copolymer can be RICON® 100, RICON® 181, or RICON® 257. A model of the copolymer polymerized from butadiene and other monomers (excluding styrene) can be TE2000. Models of the butadiene homopolymer can be RICON® 150, ACTIV® 50, ACTIV® 1000, B-1000, B-2000, and B-3000. However, the present disclosure is not limited thereto.

In Table 1, the polyphenylene ether resin is the polyphenylene ether that has two methacryl modified groups at the two molecular ends thereof. The crosslinker can be triallyl isocyanurate (TAIC).

In Table 1, the thermal conductive filler can be aluminum oxide or boron nitride. In addition, the aluminum oxide is processed by the surface modifier process to have an acryl group, while the boron nitride does not undergo the surface modification process. A boron nitride A, a boron nitride B, and a boron nitride C are each an aggregated boron nitride that has a different particle size. Specifically, a D₅₀ particle size of the boron nitride A is 20 μm, a D₅₀ particle size of the boron nitride B is 25 μm, and a D₅₀ particle size of the boron nitride C is 28 μm. The dielectric filler is silicon dioxide, and the silicon dioxide can be processed by the surface modified process.

In Table 1, the siloxane coupling agent can be a siloxane that has an acryl group at molecular ends thereof, a siloxane that has an ethyl group at molecular ends thereof, or a siloxane that has an amino group at molecular ends thereof. Further, the compatibility among the fiber cloth, the rubber resin composition, and the fillers can be enhanced by the siloxane that has an acryl group at the molecular ends thereof and the siloxane that has an ethyl group at the molecular ends thereof.

Subsequently, a glass fiber cloth produced by Nan Ya Plastics Corporation as the model 1078 is immersed into the rubber resin material in each of Examples 1 to 6 and Comparative Examples 1 to 3. After immersion, drying, and molding, a prepreg is obtained. After the prepreg is processed, a metal layer is disposed on the prepreg, so as to form the metal substrate of Examples 1 to 6 and Comparative Examples 1 to 3. Properties of the metal substrate of Examples 1 to 6 and Comparative Examples 1 to 3 are listed in Table 1.

In Table 1, the properties of the metal substrate are measured by methods below.
(1) Dielectric constant (10 GHz): detecting the dielectric constant of the metal substrate at 10 GHz by a dielectric analyzer (model: HP Agilent E5071C).
(2) Dielectric dissipation factor (10 GHz): detecting the dielectric dissipation factor of the metal substrate at 10 GHz by the dielectric analyzer (model: HP Agilent E5071C).
(3) Peeling strength: measuring the peeling strength of the metal substrate according to the IPC-TM-650-2.4.8 test method.
(4) Thermal resistance: heating the metal substrate in an autoclave at a temperature of 120° C. and a pressure of 2 atm for 120 minutes, and then putting said metal substrate into a soldering furnace of 288° C., so as to record the time needed for delamination.
(5) Thermal conductivity: measuring a thermal conductivity of the metal substrate according to the ASTM D5470 test method.

TABLE 1

| | | | | | | | | | | Comparative | | |
|---|---|---|---|---|---|---|---|---|---|---|---|---|
| | | | Example | | | | | | | Example | | |
| (unit: phr) | | | 1 | 2 | 3 | 4 | 5 | 6 | 7 | 1 | 2 | 3 |
| Rubber | Liquid | Butadiene/styrene copolymer | 20 | 20 | 20 | 0 | 0 | 20 | 0 | 0 | 20 | 20 |
| resin | rubber | Butadiene copolymer containing | 0 | 0 | 0 | 20 | 0 | 0 | 0 | 0 | 0 | 0 |
| composition | | polyurethane | | | | | | | | | | |
| | | Butadiene homopolymer A | 0 | 0 | 0 | 0 | 20 | 0 | 0 | 0 | 0 | 0 |
| | | Butadiene homopolymer B | 0 | 0 | 0 | 0 | 0 | 0 | 20 | 0 | 0 | 0 |
| | | Butadiene homopolymer C | 0 | 0 | 0 | 0 | 0 | 0 | 0 | 20 | 0 | 0 |
| | Polyphenylene ether resin | | 10 | 10 | 10 | 10 | 10 | 10 | 10 | 10 | 10 | 10 |
| | Crosslinker | | 10 | 10 | 10 | 10 | 10 | 10 | 10 | 10 | 10 | 10 |
| Inorganic | Dielectric | Silicon dioxide | 10 | 10 | 10 | 10 | 10 | 10 | 10 | 10 | 10 | 10 |
| fillers | filler | | | | | | | | | | | |
| | Thermal | Aluminum oxide | 10 | 10 | 10 | 10 | 10 | 10 | 10 | 10 | 40 | 10 |
| | conductive | Boron nitride A | 40 | 0 | 0 | 40 | 40 | 40 | 40 | 40 | 10 | 40 |
| | filler | Boron nitride B | 0 | 40 | 0 | 0 | 0 | 0 | 0 | 0 | 0 | 0 |
| | | Boron nitride C | 0 | 0 | 40 | 0 | 0 | 0 | 0 | 0 | 0 | 0 |

| | | | | | | | | | | | |
|---|---|---|---|---|---|---|---|---|---|---|---|
| Siloxane | Siloxane having an acryl group at molecular ends | 1 | 1 | 1 | 1 | 1 | 0 | 0 | 1 | 1 | 0 |
| coupling | thereof | | | | | | | | | | |
| agent | Siloxane having an ethylene group at molecular ends | 0 | 0 | 0 | 0 | 0 | 1 | 0 | 0 | 0 | 0 |
| | thereof | | | | | | | | | | |
| | Siloxane having an amino group at molecular ends | 0 | 0 | 0 | 0 | 0 | 0 | 1 | 0 | 0 | 1 |
| | thereof | | | | | | | | | | |
| Metal | Dielectric constant (10 GHz) | 3.74 | 3.75 | 3.71 | 3.74 | 3.72 | 3.71 | 3.81 | 3.71 | 3.65 | 3.72 |
| substrate | Dielectric dissipation factor (10 GHz) × 10³ | 3.0 | 3.0 | 2.9 | 2.8 | 2.7 | 2.8 | 3.2 | 2.8 | 2.6 | 3.1 |
| | Peeling strength (lb/in) | 5.2 | 5.1 | 5.4 | 5.3 | 5.1 | 5.2 | 5.6 | 2.4 | 5.6 | 3.8 |
| | Thermal resistance | OK | OK | OK | OK | OK | OK | OK | NG | OK | NG |
| | Thermal conductivity (W/m · K) | 1.21 | 1.28 | 1.31 | 1.22 | 1.22 | 1.21 | 1.23 | 1.21 | 0.8 | 1.22 |

According to Table 1, by controlling contents of the liquid rubber, the polyphenylene ether resin, and the crosslinker, the metal substrate of Examples 1 to 6 can have good dielectric properties, a good peeling strength, a good thermal resistance, and a good thermal conductivity. Even when the rubber resin composition contains a high content (higher than 25 wt %) of the liquid rubber, the metal substrate of the present disclosure still can have a good peeling strength.

Specifically, in the present disclosure, the dielectric constant (10 GHz) of the metal substrate is lower than or equal to 4.0. Preferably, the dielectric constant (10 GHz) of the metal substrate ranges from 3.0 to 3.9. More preferably, the dielectric constant (10 GHz) of the metal substrate ranges from 3.5 to 3.8. The dielectric dissipation factor (10 GHz) of the metal substrate is lower than or equal to 0.0035. Preferably, the dielectric dissipation factor (10 GHz) of the metal substrate is lower than or equal to 0.0032. More preferably, the dielectric dissipation factor (10 GHz) of the metal substrate is lower than or equal to 0.0030. The peeling strength of the metal substrate ranges from 4.5 lb/in to 7 lb/in. Preferably, the peeling strength of the metal substrate ranges from 5 lb/in to 7 lb/in. The thermal conductivity of the metal substrate ranges from 0.8 W/m·K to 2 m K. Preferably, the thermal conductivity of the metal substrate ranges from 1 W/m·K to 2 m K. More preferably, the thermal conductivity of the metal substrate ranges from 1.2 W/m·K to 2 m K.

According to Table 1, when the styrene monomer is absent from the liquid rubber, the reactivity of the rubber resin composition is decreased, thereby negatively influencing the peeling strength of the metal substrate. In Comparative Example 1, the liquid rubber only contains the butadiene homopolymer (i.e., RICON® 150) and does not contain the styrene monomer, thereby causing the peeling strength of the metal substrate to be low.

According to Comparative Example 2, by controlling the amount of the boron nitride being 15 phr to 100 phr relative to 100 phr of the rubber resin composition, the thermal conductivity of the metal substrate can be increased. In Comparative Example 2, since the amount of the boron nitride is only 10 phr (lower than 15 phr), the thermal conductivity of the metal substrate cannot be effectively increased.

According to Comparative Example 3, when the siloxane has at least one of an acryl group and an ethylene group at the molecular ends thereof, the reactivity and the compatibility among the fiber cloth, the rubber resin composition, and the fillers can be enhanced, thereby enhancing the peeling strength and the thermal resistance of the metal substrate. In Comparative Example 3, the siloxane has an amino group at the molecular ends thereof, such that the peeling strength and the thermal resistance of the metal substrate cannot be effectively enhanced.

### Beneficial Effects of the Embodiments

In conclusion, in the rubber resin material with high thermal conductivity and a metal substrate with high thermal conductivity provided by the present disclosure, by virtue of “the rubber resin composition with high thermal conductivity including 40 wt % to 70 wt % of a liquid rubber” and “the inorganic fillers undergoing a surface modification process to have at least one of an acryl group and an ethylene group”, the rubber resin material and the metal substrate can be improved with respect to their dielectric properties, peeling strength, the thermal resistance, and the thermal conductivity.

In addition, by virtue of “the monomers forming the liquid rubber including a styrene monomer and a butadiene monomer”, the peeling strength of the metal substrate can be enhanced.

Moreover, by virtue of “the thermal conductive filler including aluminum oxide, boron nitride, and aluminum silicate” and “relative to 100 phr of the rubber resin composition with high thermal conductivity, an amount of the aluminum oxide ranging from 5 phr to 120 phr, an amount of the boron nitride ranging from 10 phr to 100 phr, and an amount of the aluminum silicate ranging from 30 phr to 80 phr”, the thermal conductivity of the metal substrate can be increased.

Furthermore, by virtue of “the siloxane coupling agent having at least one of an acryl group and an ethylene group”, the peeling strength and the thermal resistance of the metal substrate can be enhanced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A rubber resin material with high thermal conductivity, comprising inorganic fillers and a rubber resin composition with high thermal conductivity, wherein the rubber resin composition with high thermal conductivity includes:
40 wt % to 70 wt % of a liquid rubber, a molecular weight of the liquid rubber ranging from 800 g/mol to 6000 g/mol;
10 wt % to 30 wt % of a polyphenylene ether resin; and
20 wt % to 40 wt % of a crosslinker;
wherein the inorganic fillers undergo a surface modification process to have at least one of an acryl group and an ethylene group.

2. The rubber resin material with high thermal conductivity according to claim 1, wherein monomers forming the liquid rubber include a styrene monomer and a butadiene monomer, and based on a total weight of the liquid rubber being 100 wt %, an amount of the styrene monomer ranges from 10 wt % to 50 wt %.

3. The rubber resin material with high thermal conductivity according to claim 2, wherein, based on a total weight of the butadiene monomer being 100 wt %, 30 wt % to 90 wt % of the butadiene monomer has a side chain containing an ethylene group.

4. The rubber resin material with high thermal conductivity according to claim 1, wherein the inorganic fillers include a thermal conductive filler, and the thermal conductive filler undergoes the surface modification process to have at least one of an acryl group and an ethylene group.

5. The rubber resin material with high thermal conductivity according to claim 4, wherein the thermal conductive filler is selected from the group consisting of: aluminum oxide, boron nitride, magnesium oxide, zinc oxide, aluminum nitride, silicon carbide, and aluminum silicate.

6. The rubber resin material with high thermal conductivity according to claim 4, wherein, relative to 100 phr of the rubber resin composition with high thermal conductivity, an amount of the thermal conductive filler ranges from 100 phr to 150 phr.

7. The rubber resin material with high thermal conductivity according to claim 4, wherein the thermal conductive filler includes aluminum oxide, boron nitride, and aluminum silicate, and relative to 100 phr of the rubber resin composition with high thermal conductivity, an amount of the aluminum oxide ranges from 5 phr to 120 phr, an amount of the boron nitride ranges from 10 phr to 100 phr, and an amount of the aluminum silicate ranges from 30 phr to 80 phr.

8. The rubber resin material with high thermal conductivity according to claim 1, wherein the inorganic fillers include a dielectric filler, and the dielectric filler includes silicon dioxide.

9. The rubber resin material with high thermal conductivity according to claim 8, wherein, relative to 100 phr of the rubber resin composition with high thermal conductivity, an amount of the dielectric filler ranges from 50 phr to 100 phr.

10. The rubber resin material with high thermal conductivity according to claim 1, further comprising: a siloxane coupling agent, wherein the siloxane coupling agent has at least one of an acryl group and an ethylene group.

11. The rubber resin material with high thermal conductivity according to claim 10, wherein, relative to 100 phr of the rubber resin composition with high thermal conductivity, an amount of the siloxane coupling agent ranges from 0.1 phr to 5 phr.

12. A metal substrate with high thermal conductivity, comprising a substrate layer and a metal layer disposed on the substrate layer, wherein the substrate layer is formed from a rubber resin material with high thermal conductivity, the rubber resin material with high thermal conductivity includes a rubber resin composition with high thermal conductivity and inorganic fillers, and the rubber resin composition with high thermal conductivity includes:
40 wt % to 70 wt % of a liquid rubber, a molecular weight of the liquid rubber ranging from 800 g/mol to 6000 g/mol;
10 wt % to 30 wt % of a polyphenylene ether resin; and
20 wt % to 40 wt % of a crosslinker;
wherein the inorganic fillers undergo a surface modification process to have at least one of an acryl group and an ethylene group.

13. The metal substrate with high thermal conductivity according to claim 12, wherein a thermal conductivity of the metal substrate with high thermal conductivity is higher than or equal to 1.2 W/m·K.

14. The metal substrate with high thermal conductivity according to claim 12, wherein a peeling strength of the metal substrate with high thermal conductivity ranges from 4.5 lb/in to 7.0 lb/in.

15. The metal substrate with high thermal conductivity according to claim 12, wherein the metal substrate with high thermal conductivity has a dielectric constant that ranges from 3.5 to 4.5 and a dielectric dissipation factor that is lower than or equal to 0.0035.
